(19) United States
(12) Patent Application Publication
(10) Pub. No.: US 2012/0149483 A1
(43) Pub. Date: Jun. 14, 2012

(54) Golf Swing Training Device

(76) Inventor: Jerry Donahue, Purcellville, VA (US)

(21) Appl. No.: 13/012,783

(22) Filed: Jan. 24, 2011

Related U.S. Application Data
(60) Provisional application No. 61/422,581, filed on Dec. 13, 2010.

(51) Int. Cl. A63B 69/36; G06F 19/00

(52) U.S. Cl. 473/231; 473/256; 700/91

(57) ABSTRACT

A golf swing training device for improving a user's strength, flexibility, balance and weight transfer as well as teaching proper rotation of wrists and forearms is disclosed. The training device includes a weighted shaft having a proximal and distal end, the weight being evenly distributed along the length of the shaft. The shaft includes first and second indicia along the entire length of the shaft, the first indicia located on one side of the shaft, and the second indicia located on the opposite side of the shaft. In embodiments, a user interface calculates a customized training device based on user information.

This application claims benefit to U.S. Provisional Patent Application No. 61/422,581 filed Dec. 13, 2010, the entire contents incorporated herein by reference.

### BACKGROUND OF THE DISCLOSURE

1. Field of the Disclosure

The present disclosure relates generally to golf swing training aids. More specifically, the present disclosure relates to a golf swing training device for improving user strength, flexibility, speed, balance, weight shift and wrist rotation.

2. Background of the Disclosure

A typical golf swing comprises several distinct movements including the “backswing,” “downswing,” “impact,” and “follow-through.” During the backswing, the body twists to raise the golf club up in a rear-ward position and thereby establish potential energy. In the downswing, striking power is generated as the arms swing down and forward. Just before impact, the club is released to hit the ball. Much focus is often directed toward increasing speed and striking power in the downswing in order to hit the ball farther. However, the importance of properly rotating one's wrists and forearms during the downswing, impact, and follow-through is often overlooked.

Rotation of the wrists and forearms allows energy from one's arms to be passed to the club in an optimal manner and can have a significant impact on overall performance. However, this is easier said than done as proper timing and extent of rotation is often difficult to achieve. For example, if a golfer rotates their wrists too soon or too far, they may end up hooking the ball. On the other hand, if a golfer rotates their wrists too slow, or not enough, a slice may result. Moreover, failure to rotate one's arms and wrists at all will generally cause the ball to land short.

Swinging a golf club also involves many coordinated movements of the body and use of specific muscle groups. For example, during the backswing, it is desirable to have maximum flexibility to fully rotate one's core and shoulders for maximum torque. During the downswing, tricep and forearm strength are desirable for increasing speed, properly releasing the club, and increasing power at impact. Throughout one's overall swing, it is also important to maintain proper balance for effective transfer of energy.

Despite all the different factors that go into improving one's golf swing, most prior art golf training devices typically only focus on one factor such as swing speed, or strength. For example, some training devices contain gauges to measure swing speed. However, such devices tend to discourage practice of actual golf swings and are not heavy enough to train the particular muscles used during the backswing and downswing. These devices also encourage users to swing harder which has the adverse effect of creating muscular tension, thus reducing one's flexibility and speed.

While some golf swing training devices contain unequally distributed weights e.g., on the distal “clubhead” portion to increase strength, such devices also do not properly train the correct muscles used during a normal golf swing. This is because during the forward swing, the weighted “clubhead” portion creates its own momentum, causing an “un-natural” pull. As a result, such devices also inhibit proper balance, as well as induce a false sense of timing for releasing the club. In addition, unequally distributed weights do not provide optimal resistance and control for training proper muscle groups.

Many other training devices require attachments to a golf club. However, these attachments tend to be awkward, and interfere with one's normal golf swing. In addition, such attachments are prone to shifting or coming loose from the club, thereby becoming a nuisance and distraction to the golfer.

None of the prior art provides a golf swing training aid that improves golfer flexibility, strength, speed, balance, weight transfer and timing and well as proper arm and wrist rotation in a comprehensive manner. The present disclosure addresses these needs and others.

### SUMMARY OF THE DISCLOSURE

The present disclosure overcomes drawbacks of the prior art by providing a golf swing training device having a total weight between 1.5 to 5.0 lbs evenly distributed along the entire length. The length is designed to allow a user to practice an actual golf swing, and the evenly distributed weight causes muscles involved in the actual golf swing to be exercised in a controlled manner and with optimal resistance. The present disclosure also overcomes drawbacks of the prior art by providing a golf swing training device having first and second longitudinally disposed indicia that enable both peripheral and direct visual indication to the user of proper arm and wrist rotation during the golf swing. The present disclosure also overcomes drawbacks of the prior art by further enabling the training device to be customized to a user's needs.

Unlike training devices which are designed to focus on one aspect of a golf swing at a time, cannot be used to practice an actual golf swing, or require awkward attachments—the disclosed device comprehensively improves golfer flexibility, strength, speed, balance and weight transfer. In addition, the device also teaches proper extent and timing of arm and wrist rotation.

According to one aspect, the disclosure provides a golf swing training device comprising: an elongate shaft having a proximal end and a distal end; a handle disposed on the proximal end of the shaft; the shaft and handle having a combined length between 40-50 inches; the shaft further having a total weight between 1.5 to 5.0 lbs evenly distributed along the entire length of the shaft; wherein the combined length of the shaft and handle enables a user to practice an actual golf swing and the evenly distributed weight of the shaft causes muscles involved in the actual golf swing to be exercised in a controlled manner with optimal resistance. In further embodiments, the weight of the shaft is at least between 2.5-5.0 lbs.

In embodiments, the training device further comprises first and second visible indicia longitudinally disposed along the entire length of the shaft, the first indicia located on one side of the shaft and the second indicia located on the opposite side of the shaft from the first indicia. Depending on a user's trajectory tendencies (e.g., to hook, slice, etc.), the first indicia may be longitudinally disposed on half, less than half, or more than half of the shaft to indicate how much arm and wrist rotation during the swing is necessary to obtain a straight trajectory. In embodiments, the first indicia comprises a highly visible solid color, pattern, and/or reflective material for enhanced direct or peripheral detection.

In further embodiments, the length and/or weight of the shaft is customized to the user based at least on: height, gender, and/or age.

According to another aspect, the disclosure provides a golf swing training device comprising: an elongate shaft having a proximal end and a distal end; a handle disposed on the proximal end of the shaft; the shaft and handle having a combined length between 40-50 inches; the shaft further comprising first and second visible indicia longitudinally disposed along the entire length of the shaft, the first indicia located on one side of the shaft and the second indicia located on the opposite side of the shaft from the first indicia, wherein the combined length of the shaft and handle enables a user to practice an actual golf swing and the first and second indicia enable both peripheral and direct visual indication to the user of proper extent and timing of arm and wrist rotation during the golf swing.

Depending on a user's trajectory tendencies (e.g., to hook, slice, etc.), the first indicia may be longitudinally disposed on half, less than half, or more than half of the shaft to indicate how much arm and wrist rotation during the swing is necessary to obtain a straight trajectory. In other embodiments, the first indicia comprises a highly visible solid color, pattern, and/or reflective material for enhanced direct or peripheral detection.

In embodiments, the weight of the shaft is between 1.5-5.0 lbs, and in some cases between 2.5-5.0 lbs.

In further embodiments, the length and/or weight of the shaft is customized to the user based at least on: height, gender, and/or age.

According to yet another aspect, the disclosure provides a computerized user-interface for calculating and displaying a customized/recommended golf swing training device for a user, the user-interface comprising: a display having input and output modules, the input modules configured to receive user data; a calculation module that determines a recommended length and weight of the training device customized to the user based on the entered user data; the output module configured to display the recommended length and weight results determined by the calculation module to the user. In embodiments, the user data corresponds at least to height, gender, and/or age, and the calculation module determines the proper length and weight of the training device based on this data.

Among the many other advantages of the disclosed golf swing training device are that it:
can be used at home, the office, or practically anywhere;
trains/strengthens the muscles that are used during a normal golf swing;
may be customizable to a user in weight or length;
indicates proper forearm and wrist rotation;
increases golfer swing speed;
increases golfer flexibility;
improves golfer release;
improves golfer balance;
increases golfer confidence;
provides comprehensive golf swing improvement.

### BRIEF DESCRIPTION OF THE DRAWINGS

FIG. 1 shows a front view of an exemplary golf swing training device according to a preferred embodiment of the present disclosure.

FIG. 2a shows a side view of the golf swing training device shown in FIG. 1.

FIG. 2b shows a side view of the golf swing training device opposite that shown in FIG. 2a.

FIG. 2c shows a cross-sectional view of the golf swing training device along line A-A of FIG. 1.

FIG. 3 shows a front view of an exemplary golf swing training device according to another embodiment of the present disclosure.

FIG. 4a shows a side view of the golf swing training device shown in FIG. 3.

FIG. 4b shows a side view of the golf swing training device opposite that shown in FIG. 4a.

FIG. 4c shows a cross-sectional view of the golf swing training device along line A-A′ of FIG. 3.

FIGS. 5a-d depict positioning of the training device corresponding to different phases of a golf swing.

FIGS. 6a-c illustrate a user interface and calculation module configured to determine a golf swing training device best suited for an individual.

### DETAILED DESCRIPTION OF VARIOUS EMBODIMENTS OF THE DISCLOSURE

Reference will now be made in detail to various exemplary embodiments of the disclosure, examples of which are illustrated in the accompanying drawings. The following detailed description describes certain embodiments of the disclosure, and should not be considered as limiting the disclosure to those embodiments.

The present disclosure addresses problems associated with under-developed strength, flexibility, balance, weight transfer, timing and arm/wrist rotation with respect to one's overall golf swing. To remedy these problems, the present disclosure provides a comprehensive training device that one may use to practice their actual golf swing that is specifically weighted to train relevant muscle groups while improving flexibility, balance and weight transfer. At the same time, the disclosure provides first and second indicia longitudinally disposed on either side of the shaft to aid in proper arm and wrist rotation during the downswing.

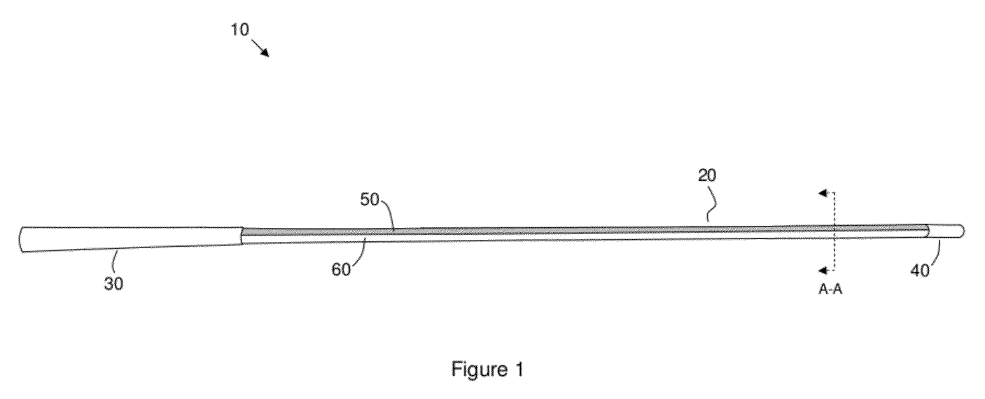

Turning now to the figures, which depict various exemplary embodiments of the disclosure, FIG. 1 shows a front view of a preferred golf swing training device 10. The training device 10 comprises an elongate shaft 20 having proximal and distal ends. As shown in the Figure, a handle 30 is coupled to the proximal end of the shaft 20 and an optional safety cap 40 is coupled to the distal end. The length of the shaft 20 is approximately 40-50 inches (depending on the user), the length corresponding to the length of a typical driver, wedge, etc.

The shaft 20 is preferably composed of steel, particularly for its weight and cost properties, however it is contemplated that other suitable materials may be used. Advantageously, the weight of the shaft is between 1.5-5.0 lbs—noticeably heavier than a typical driver or wedge. Specifically, it has been directly observed that a shaft 20 having a weight approximately 2 to 4 times the weight of a typical driver or wedge is ideal for training muscles in the arms, shoulders and core without inducing injury for most individuals. In some cases, a higher weight e.g., 2.5-5.0 lbs may provide better results, however a user may need to gradually work up to a higher weight to avoid injury. Initially, the weight of the shaft 20 may be less (e.g., for female, young, or senior golfers) or more (e.g., for male golfers). Importantly, the weight of the shaft 20 is evenly distributed throughout the length of the shaft in order to apply optimal resistance to relevant muscles in a natural and controlled manner and to minimize risk of injury. The weight of the shaft works to increase strength in the muscles used in the backswing, downswing and impact while concurrently improving balance and flexibility. For example, by practicing one's golf swing with the training device 10 two to three times a week for 20 minutes at a time, a golfer will increase the strength in at least their core, shoulder, bicep and forearm muscles.

Also shown in FIG. 1, are first and second indicia, 50 and 60 respectively. The indicia are longitudinally disposed along the entire length of the shaft 20, where the first indicia 50 is located on one side of the shaft 20, and second indicia 60 is located on the opposite side of the shaft 20.

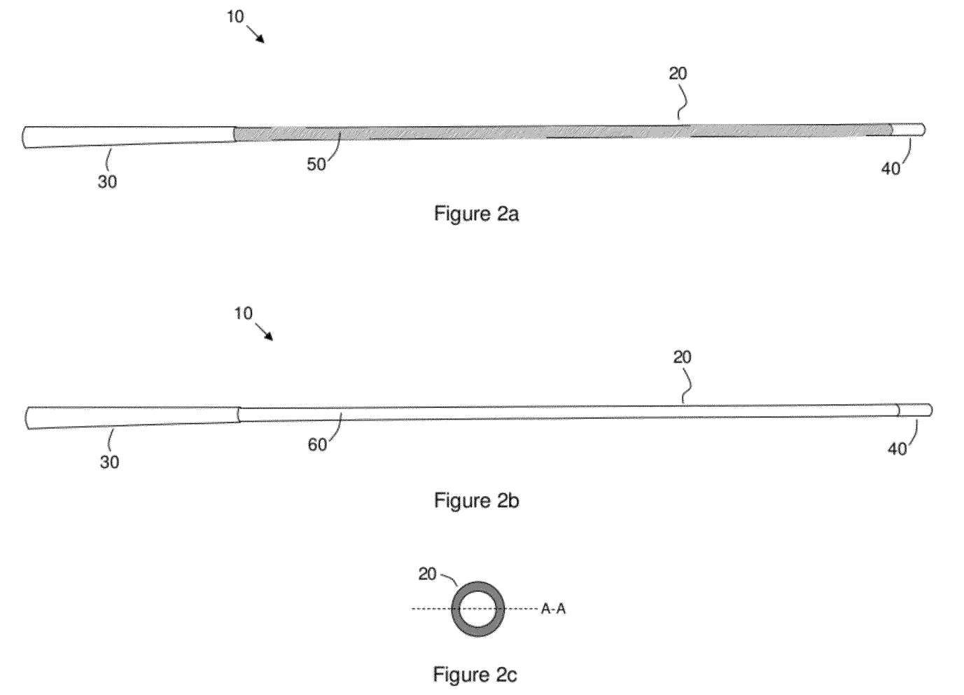

FIG. 2a shows a side view of the training device 10 of FIG. 1. The first indicia 50 can be seen in this figure extending the length of the shaft 20 on one side. It is appreciated that the first indicia 50 may be an easily detectable color (such as yellow, green, orange), a reflective material, pattern, or the like. FIG. 2b shows the side of the training device 10 opposite from FIG. 2a. Here, the second indicia 60 (e.g., represented by a different color from the first indicia 50) is seen extending the length of the shaft 20.

FIG. 2c shows a cross-sectional view of the shaft 20 as seen from line A-A in FIG. 1. As seen in the figure, the shaft 20 is hollow, however in other embodiments the shaft may have a solid cross-section.

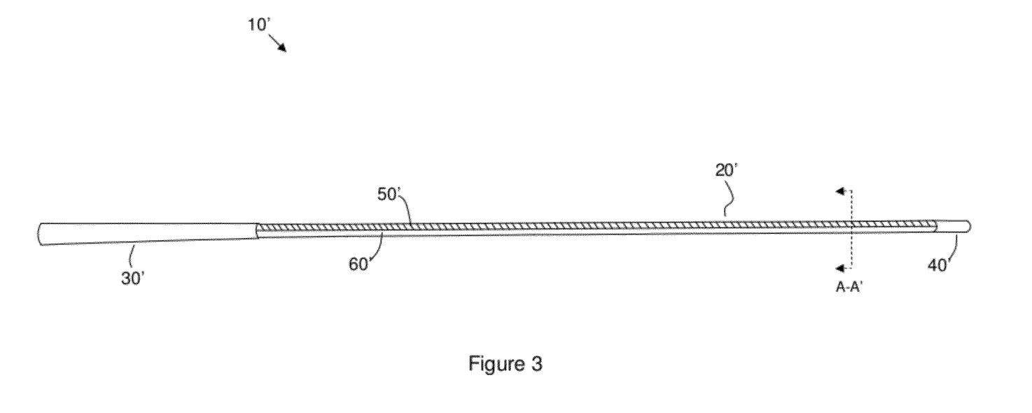

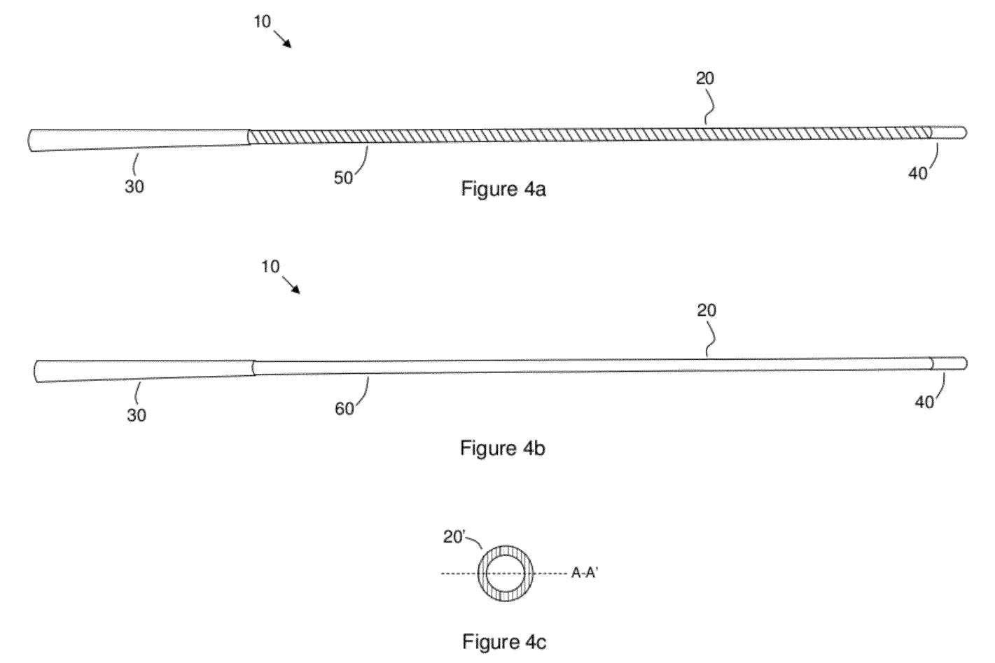

FIGS. 3, 4a and 4b show another embodiment of the present disclosure with like elements 10′, 20′, 30′, 40′, 50′ and 60′. Again, indicia 50′, 60′ are longitudinally disposed along the entire length of the shaft 20′, where the first indicia 50′ is located on one side of the shaft 20′, and second indicia 60′ is located on the opposite side of the shaft 20. First and second indicia 50′, 60′ may be comprised of an easily detectable color (including but not limited to yellow, green, orange), pattern, reflective material, or the like.

FIG. 4c shows a cross-sectional view of the shaft 20′ as seen from line A-A′ in FIG. 3. As seen in the figure, the shaft 20′ is hollow, however in other embodiments the shaft may have a solid cross-section.

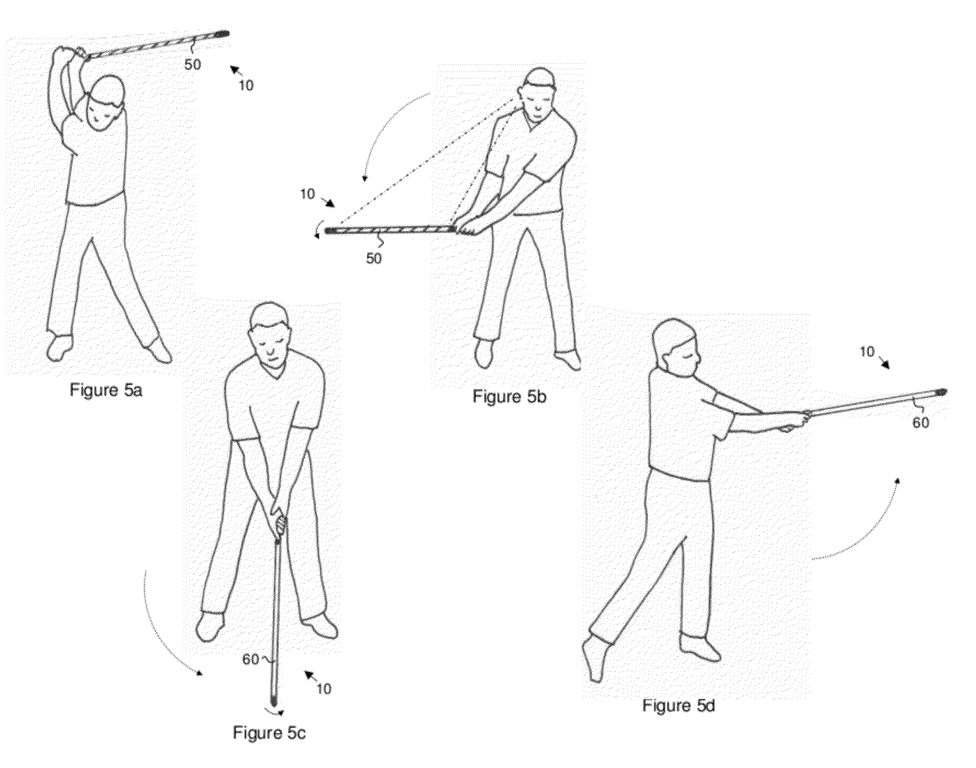

In operation, a user performs several repetitions of practice golf swings using the training device 10. FIGS. 5a-d show proper orientations of the device at different phases of a golf swing. FIG. 5a illustrates the device 10 during a backswing. In the backswing, the user's hands are moved back and hinged. (In a real golf swing, the club face would typically be open in this position). Here, the first indicia 50 is positioned facing the user and may correspond to an ‘open club face.’ As the device 10 is brought down (indicated by dotted arrow) to the horizontal position of FIG. 5b, the first indicia 50 should be easily detectable via the user's side, or peripheral, vision (indicated by dashed lines). It is important that the indicia 50, 60 are disposed the full length of the shaft so that they are easily detectable during the entire swing and the user need not turn their head at any point to check proper rotation of the training device 10. As a result, the user can develop a steady swing with a fixed gaze on the intended target. It is noted here that a golf ball is not used while practicing swings with the device 10. However, to provide the user with a target, a flat guide may be placed on the floor to represent an intended target.

Between the downswing position shown in FIG. 5b and right before impact (FIG. 5c), the user begins to rotate their wrists. Movement of the shaft 20 (indicated by dotted arrows) between the horizontal position (FIG. 5b), the bottom of the downswing (FIG. 5c), and the follow-through (FIG. 5d) should reflect a natural rotation of the wrists as the left forearm is brought over the right forearm for a right handed golfer (or vice versa for a left handed golfer). Proper timing and rotation of the wrists during this phase is important to developing an accurate golf swing. As the wrists and forearms rotate, the device 10 is gradually rotated about its long axis (indicated by small arrow) until the user is directly viewing the second indicia 60 at the bottom of the downswing (corresponding to a ‘closing’ of the club face) and into the follow-through.

As a result, the first indicia 50 and second indicia 60 help to teach a user proper timing and amount of wrist motion. Additionally, the distributed weight of the shaft 20 serves to strengthen the forearm and wrist muscles during rotation.

It can be seen from the above discussion that it is helpful for the first and second indicia 50, 60 to extend the entire length of the training device 10 so that the user can easily monitor proper full swing alignment both directly and peripherally. In this way, the user need not turn their head at any point to check proper rotation of the training device 10. In other words, by having first and second indicia (50, 60) extend the length of the device 10, proper arm and wrist rotation can be visualized through one's full field of view as the device is slowly rotated from first indicia 50 to second indicia 60.

It is important that at least the first indicia 50 is easily detectable and contrasts well with the surrounding environment. In embodiments, the first indicia 50 comprises a bright solid color (including but not limited to, orange, yellow, or green) and/or pattern. In other embodiments, the first indicia 50 is a reflective material or other suitable material that reflects, or enhances, light.

In embodiments, the device 10 may be custom made for the user, wherein the length, weight, and handle 30 may be selected based on the user's needs and/or preferences. In other embodiments, the handle 30 may be customizable and/or interchangeable.

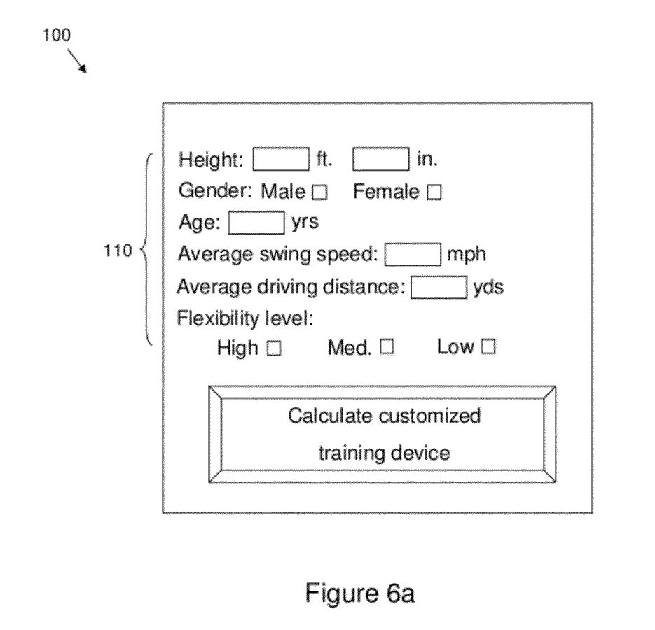

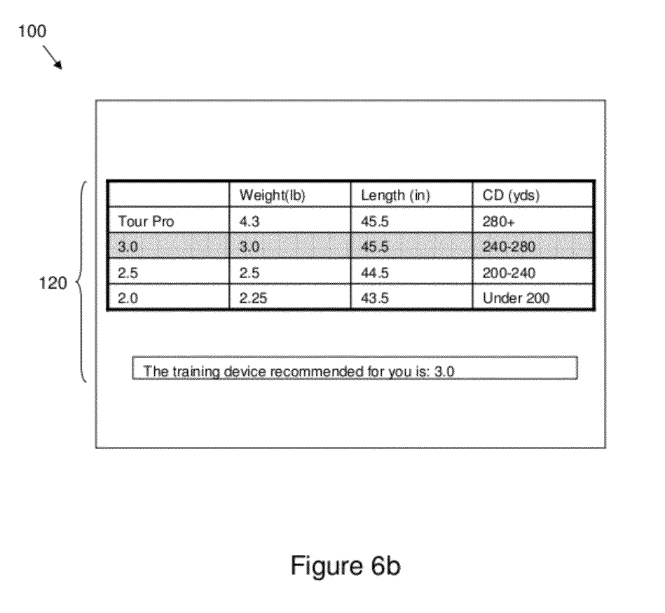

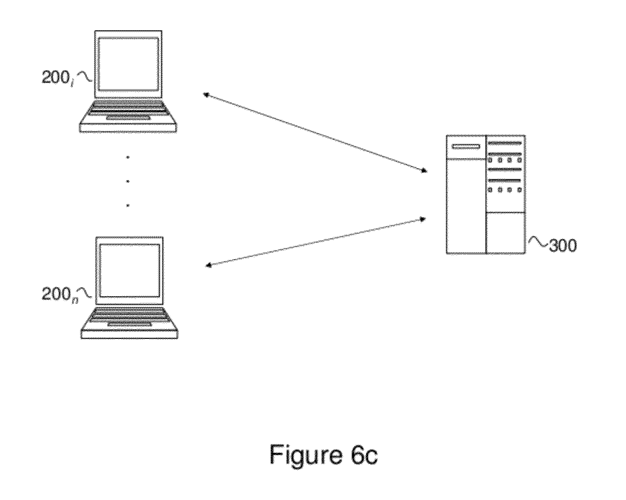

FIG. 6a depicts an exemplary web page 100 including an input module 110 for obtaining relevant user data. The data may be used to calculate a specific weight and length for a customized training device 10. Relevant user data may include, but is not limited to: height, gender, age, average swing speed, average driving distance, flexibility level, trajectory tendencies (hooking, slicing), and more. Once such data is entered in the input module 110, the user may make a selection to calculate a customized weight and length for their training device 10. Alternatively, instead of calculating a specific weight and length for each individual, the device 10 may be customized to the user based on the best selection from a range of predetermined weights and lengths. In such an embodiment, the website 100 recommends a training device 10 that falls within the best predetermined range based on the input user data. In this way, the device 10 will still meet the user's needs and can be more readily mass produced, thereby significantly decreasing cost to the consumer.

FIG. 6b shows an exemplary web page 100 displaying recommended results to a user via output module 120. Customized user results may include a calculated weight and length specific to the user, or a selection from various predetermined options. The recommended results may be calculated in hardware and/or software using a calculation module (e.g., a specially configured general purpose processor 200 and/or server 300). See FIG. 6c. It is appreciated that a general purpose processor 200 includes but is not limited to: personal computers, laptops, cell phones, smart phones, personal digital assistants, or the like as will be readily appreciated by those skilled in the art. In embodiments, the general purpose processor 200 includes a display for displaying the web page 100 and input/output modules 110, 120 as will be appreciated by those skilled in the art.

In embodiments, the calculation module 200, 300 is configured to calculate the weight and length of the training device best suited for the user. The calculations are based on a combination of user-provided data such as user strength, swing speed, height, gender, age, etc. Based on the calculated/recommended weight and length of device 10, the user may advantageously order their custom training device directly from the website 100. In addition, the user may order other customized options, e.g., handle type, company or tour logo lettering for the shaft, etc. via the website 100. It is further appreciated that custom user options need not be limited to the training device 10, but may also include options for custom golf clubs and other accessories based on user data entered into the website 100. It is further appreciated that instead of a website, a customized user interface integrated with a general purpose processor 200 may suffice, e.g., in the form of a kiosk, etc.

### Example

According to one non-limiting example, the training device 10 may be used by a golfer to first stretch before practice. After stretching, the golfer performs 5-15 repetitions of ½ or ¾ swings in a controlled, non-stop motion. The golfer then performs 5-15 repetitions of full swings in a controlled, non-stop motion. These repetitions are preferably performed about three times a week, and may be conducted at home, at work, on travel, at the golf course, or practically anywhere. After several weeks of physical training with the device 10, the user will see notable improvement not only in their driving distance, but in their strength, flexibility, balance, weight shift, timing and release of the club.

The foregoing disclosure of the preferred embodiments of the present disclosure has been presented for purposes of illustration and description. It is not intended to be exhaustive or to limit the disclosure to the precise forms disclosed. For example, the training device 10 may also be used as a swing alignment aid by placing on the ground in front and parallel to the shoulders. The straight line provided by the shaft 20 and/or indicia 50, 60 will help the user to maintain an even swing. Many other variations and modifications of the embodiments described herein will be apparent to one of ordinary skill in the art in light of the above disclosure.

1. A golf swing training device comprising: an elongate shaft having a proximal end and a distal end; a handle disposed on the proximal end of the shaft; the shaft further having a total weight between 1.5 to 5.0 lbs evenly distributed along the entire length of the shaft, wherein the combined length of the shaft and handle enables a user to practice an actual golf swing and the evenly distributed weight of the shaft causes muscles involved in the actual golf swing to be exercised in a controlled manner with optimal resistance.

2. The training device of claim 1, where the weight of the shaft is between 2.5-5.0 lbs.

3. The training device of claim 1, further comprising first and second visible indicia longitudinally disposed along the entire length of the shaft, the first indicia located on one side of the shaft and the second indicia located on the opposite side of the shaft from the first indicia, the first and second indicia providing both peripheral and direct visual indication to the user of proper extent and timing of arm and wrist rotation during the golf swing.

4. The training device of claim 3, where the first indicia is disposed on one half of the shaft and the second indicia is disposed on the other half of the shaft.

5. The training device of claim 3, where the first indicia is disposed on more than half of the shaft and the second indicia is disposed on less than half of the shaft.

6. The training device of claim 3, where the first indicia is disposed on less than half of the shaft and the second indicia is disposed on more than half of the shaft.

7. The training device of claim 3, where the first indicia is a highly visible solid color and the second indicia is a solid color different from the first indicia.

8. The training device of claim 3, where at least the first indicia comprises a reflective material.

9. The training device of claim 1, where the length and weight of the shaft are customized to the user based at least on: height, gender, and/or age.

10. A golf swing training device comprising: an elongate shaft having a proximal end and a distal end; a handle disposed on the proximal end of the shaft; the shaft further comprising first and second visible indicia longitudinally disposed along the entire length of the shaft, the first indicia located on one side of the shaft and the second indicia located on the opposite side of the shaft from the first indicia, wherein the combined length of the shaft and handle enables a user to practice an actual golf swing and the first and second indicia provide both peripheral and direct visual indication to the user of proper extent and timing of arm and wrist rotation during the golf swing.

11. The training device of claim 10, the shaft further having a total weight between 1.5 to 5.0 lbs evenly distributed along the entire length of the shaft, wherein the evenly distributed weight of the shaft causes muscles involved in the actual golf swing to be exercised in a controlled manner with optimal resistance.

12. The training device of claim 11, the shaft having a total weight between 2.5 to 5.0 lbs.

13. The training device of claim 10, where the first indicia is disposed on one half of the shaft and the second indicia is disposed on the other half of the shaft.

14. The training device of claim 10, where the first indicia is disposed on more than half of the shaft and the second indicia is disposed on less than half of the shaft.

15. The training device of claim 10, where the first indicia is disposed on less than half of the shaft and the second indicia is disposed on more than half of the shaft.

16. The training device of claim 10, where the first indicia is a highly visible solid color and the second indicia is a solid color different from the first indicia.

17. The training device of claim 10, where at least the first indicia comprises a reflective material.

18. The training device of claim 11, where the length and weight of the shaft are customized to the user based at least on: height, gender, and/or age.

19. A user-interface for calculating and displaying a customized golf swing training device for a user, the user-interface comprising:
a display having input and output modules, the input modules configured to receive user data;
a calculation module that determines a recommended length and weight of the training device customized to the user based on the entered user data;
the output module configured to display the recommended length and weight results determined by the calculation module to the user.

20. The user-interface of claim 19, where the user data corresponds at least to height, gender, and age, and the calculation module determines the length and weight for a customized training device based on this data.
